(19) United States
(12) Patent Application Publication
(10) Pub. No.: US 2015/0061417 A1
(43) Pub. Date: Mar. 5, 2015

(54) DEVICE FOR POWERING INTERACTIVE APPLIANCES IN MOVING PLAYGROUND EQUIPMENT

(71) Applicant: PLAYGROUND ENERGY LTD, Sofia (BG)

(72) Inventors: Hristo Buryanov Aleksiev, Sofia (BG); Ilian Vladimirov Milinov, Sofia (BG)

(73) Assignee: PLAYGROUND ENERGY LTD, Sofia (BG)

(21) Appl. No.: 14/016,041

(22) Filed: Aug. 30, 2013

(51) Int. Cl. H02K 41/02; A63G 31/00

(52) U.S. Cl. CPC H02K 41/02; A63G 31/00
USPC 310/14

(57) ABSTRACT

A device for powering interactive appliances in moving playground equipment includes an electrical generator mounted onto the moving element of the playground equipment, characterized by the design of the electrical generator, which includes a case (1) inside of which there is fixed a tube (7) made out of insulating material, on the tubes periphery surface there are fixed n number of coils (4). n is greater or equal to one. The coils (4) are divided from each other by separating insolating elements (3). Inside the tube it is placed a permanent cylindrical magnet (5) allowing for its sidestep movement along the tube. At the two ends of the tube (7) there are fixed rebound elements (6) The terminals of single coils or a group of connected coils (4) are terminals of the powering device, connected to the interactive appliances.

### TECHNICAL FIELD

The invention concerns a device for powering interactive appliances in moving playground equipment at children's playgrounds, children's establishments or in the home. The device can be used on Roundabouts, swings, seesaws, climbing walls, bicycles, treadmills, trampolines and other similar equipment with moving parts.

### PRIOR ART

There is knowledge in regard to a device for the supply of electrical power to playground equipment in particular using rechargeable batteries, that comprises a direct current electrical generator connected to an element exhibiting a cyclic motion on a playground structure. Attached to the generator, there is a controller. During children's play, the cyclic-moving element drives the generator by means of its repetitive motion. Together the generator and the controller transform part of the kinetic energy of the cyclic-moving element into electrical power. The generated electricity is stored in batteries and is being used to power mobile lights via a charging station. Drawbacks to the known device are its complex structure and the large loss of energy within the mechanical part of the device which transforms the motion of the respective elements into the rotary motion of the electrical generator's shaft.

### TECHNICAL DETAILS OF THE INVENTION

The device for powering interactive appliances in moving playground equipment includes an electrical generator mounted onto the moving element of the equipment. The electrical generator comprises a case on the inside of which there is fixed a tube made out of an insulating material. On the periphery surface of the tube there are fixed n number of coils connected in series and/or parallel, where n is greater or equal to one. Adjacent coils are divided by separating insolating elements. Inside the tube it is placed a permanent cylindrical magnet allowing for its sidestep movement along the tube. At the two ends of the tube there are fixed rebound elements off which the permanent cylindrical magnet bounces. The number of coils n is from 2 to 15.

The rebound elements can be formed using permanent magnets with their opposite poles aimed toward the cylindrical magnet, using rubber plugs, spring or elastic non-magnetic elements etc. The advantages of the device are its simplified structure, the reduced waste of energy, the ability for operation with different moving playground equipment such as swings, seesaws, trampolines and others, as well as with mobile play equipment and toys shaped like animals, automobiles, etc., for use in children's establishments and at home. It also allows for the attachment of various interactive appliances which produce visual and sound effects for the enhancement of kids' positive experiences.

### FIGURES DESCRIPTIONS

FIG. 1 presents a sectional view of the device.

FIG. 2 is an axonometric projection of the device.

FIG. 3.1 illustrates coils connected in parallel to an interactive appliance.

FIG. 3.2 illustrates coils connected in series to an interactive appliance.

FIG. 3.3 illustrates coils connected to interactive appliances as single coils.

FIG. 4 illustrates the place of mounting and use of the device with playground equipment.

FIG. 5 illustrates the place of mounting and use of the device with playground equipment.

FIG. 6 illustrates the place of mounting and use of the device with playground equipment.

FIG. 7 illustrates the place of mounting and use of the device with playground equipment.

### EXAMPLE DEPLOYMENT OF THE DEVICE

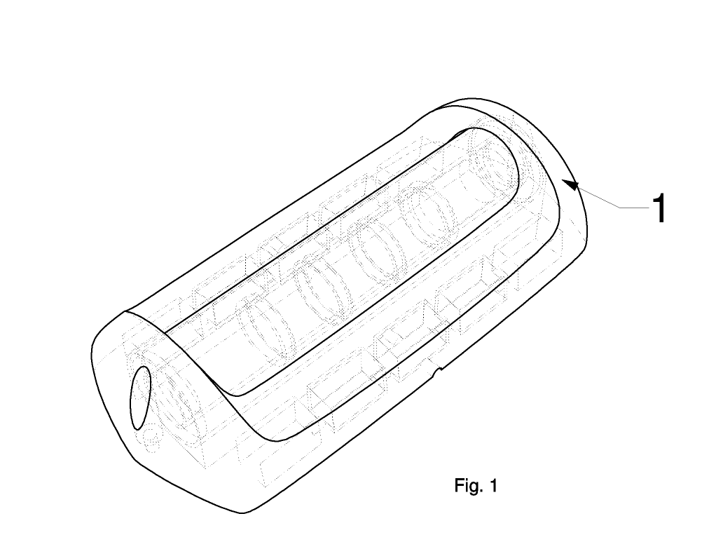

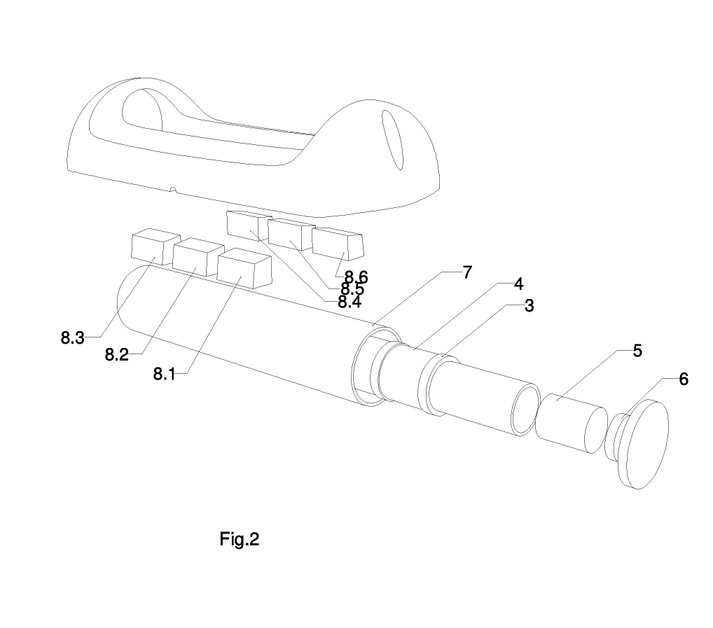

A powering device (FIGS. 1 and 2) comprises case 1 on the inside of which there is fixed a tube 7 made out of an insulating material. On the periphery surface of the tube 7 there are fixed four coils 4. The coils are divided from one another by separating insolating elements 3, where depending on the voltage or current required by the interactive appliance, the coils 4, can be arranged in groups connected in series or in parallel to each other. Inside the tube 7 it is placed a permanent cylindrical magnet 5 allowing for its sidestep movement along the tube. At the two ends of the tube 7 there are fixed rebound elements 6 off which the permanent cylindrical magnet 5 bounces. The elements 6 can be formed using permanent magnets which are directed in a way as to push away the permanent cylindrical magnet 5 which moves freely along the tube. They can also be formed using rubber plugs, spring or elastic non-magnetic elements etc.

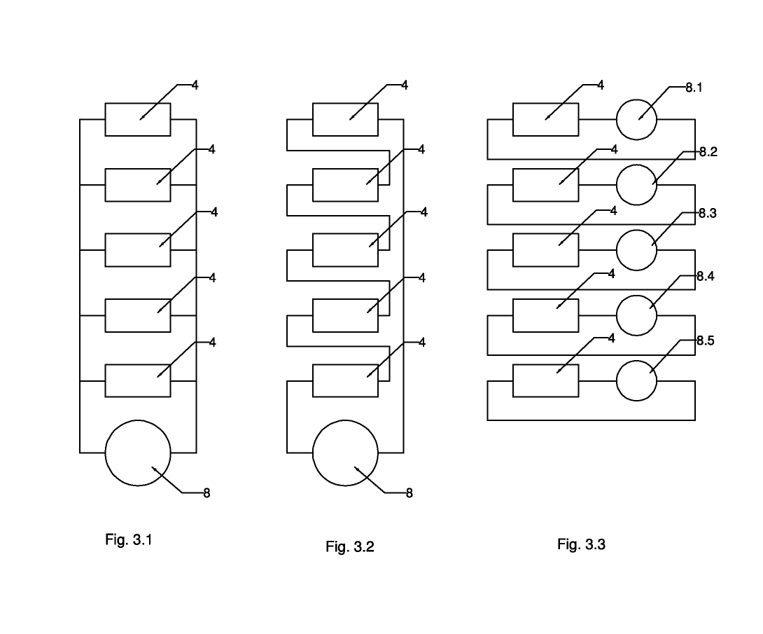

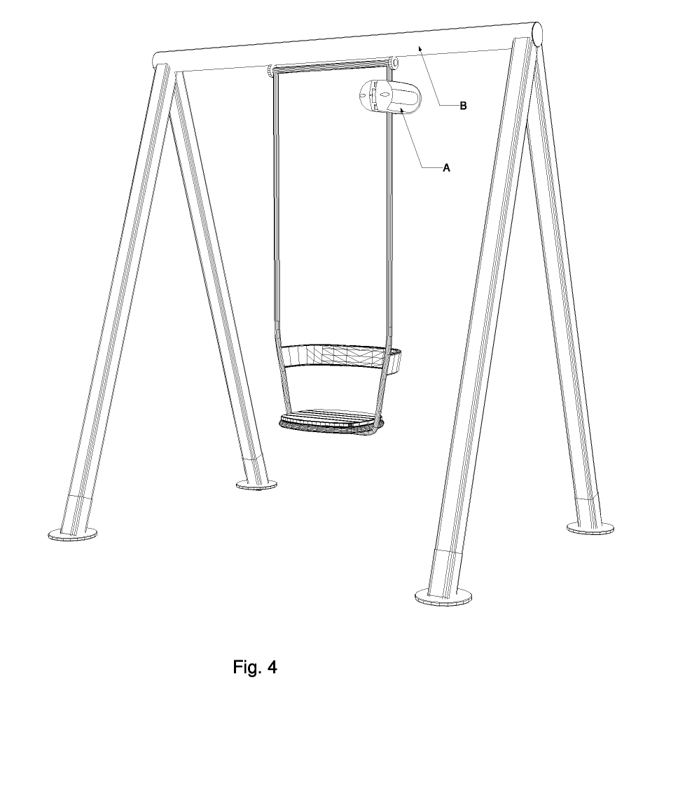

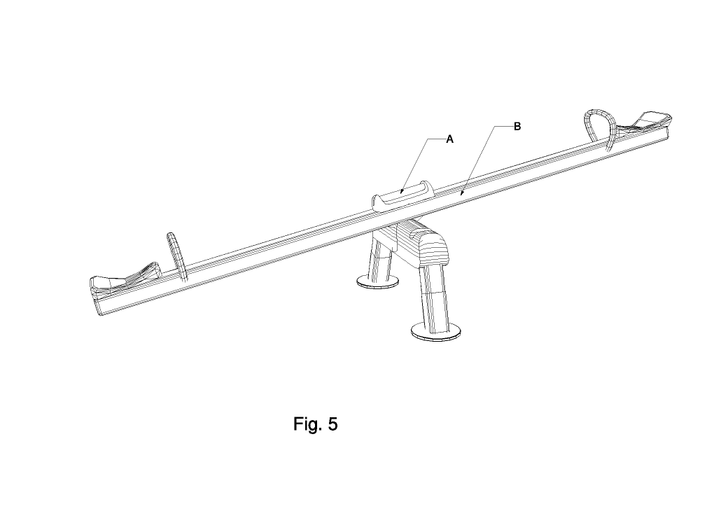

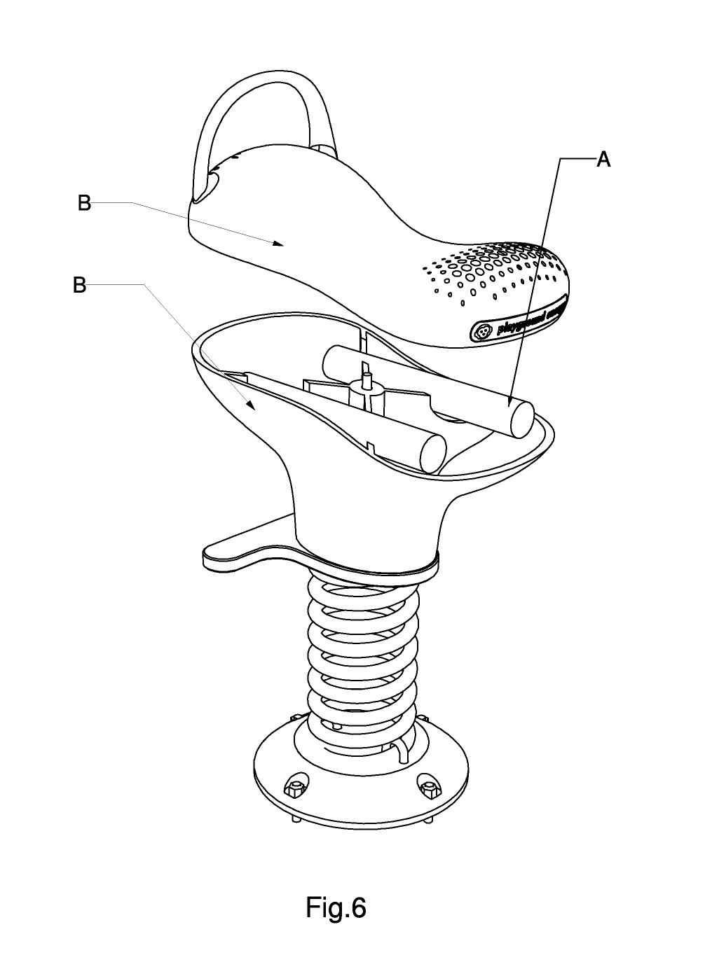

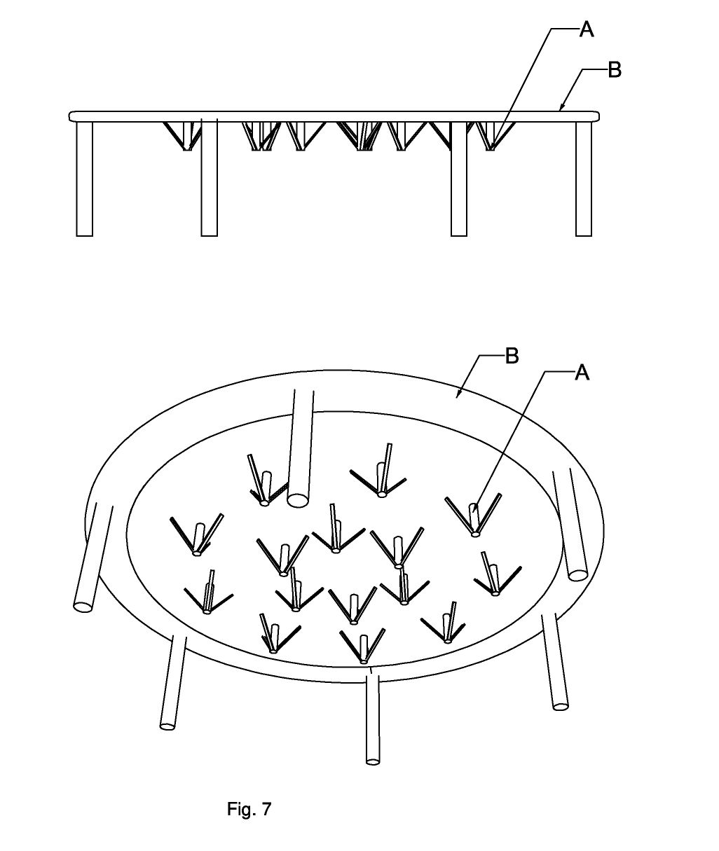

The terminals of single coils or a group of connected coils 4 (FIGS. 3.1, 3.2 and 3.3) are terminals of the powering device, connected to the various interactive appliances 8.1, 8.2, 8.3, 8.4, 8.5 and 8.6, such as a light emitter, sound emitter, battery, camera, WiFi device or projector. The powering device A is mounted onto the movable element of various moving playground equipment B, like a swing (FIG. 4), seesaw (FIG. 5), spring toy (FIG. 6) or trampoline (FIG. 7) whose movement result in the sidestep motion of the permanent magnet 5.

### Principle of the Device

By rocking the toy (the swing, the trampoline etc.) the permanent cylindrical magnet 5 moves along the tube and by this motion electrical potential is being induced in the coils 4 which are arranged around the tube 7. The potential generated in the coils 4 is channeled as to power some of the attached interactive appliances 8, such as light emitter 8.1, sound emitter 8.2, battery 8.3, camera 8.4, WiFi device 8.5, projector 8.6 etc. When the magnet 5 is at the end position, the respective rebound element 6 pushes the magnet 5 in the opposite direction.

### Summary

The invention concerns a device for powering interactive appliances in moving playground equipment for use at children's playgrounds, children's establishments or at home. The device includes an electrical generator mounted onto the moving element of the equipment. The electrical generator comprises a case on the inside of which there is fixed a tube made out of an insulating material. On the periphery surface of the tube there are fixed n number of coils connected in series and/or parallel, where n is greater or equal to one. Adjacent coils are divided from each other by separating insolating elements. Inside the tube it is placed a permanent cylindrical magnet allowing for its sidestep movement along the tube. At the two ends of the tube there are fixed rebound elements off which the permanent cylindrical magnet bounces. The number of coils n is from 2 to 15.

The rebound elements can be formed using permanent magnets with their opposite poles aimed toward the cylindrical magnet, using rubber plugs, spring or elastic non-magnetic elements etc. The advantages of the device are its simplified structure, the reduced waste of energy, the ability for operation with different moving playground equipment such as swings, seesaws, trampolines and others, as well as with mobile play equipment and toys shaped like animals, automobiles, etc., for use in children's establishments and at home. It also allows for the attachment of various interactive appliances which produce visual and sound effects for the enhancement of kids' positive experiences.

The device can be used on Roundabouts, swings, seesaws, climbing walls, bicycles, treadmills, trampolines and other similar equipment with moving parts. The device contains an electrical generator mounted onto the movable element of the equipment. The electrical generator comprises a case 1 on the inside of which there is fixed a tube 7 made out of an insulating material, on the periphery surface of the tube there are fixed n number of coils 4, where n is greater or equal to one. The coils 4 are divided from each other by separating insolating elements 3. Inside the tube 7 it is placed a permanent cylindrical magnet 5 allowing for its sidestep movement along the tube. At the two ends of the tube 7 there are fixed rebound elements 6.

The terminals of single coils 4 or a group of connected coils 4 are terminals of the powering device, connected to the interactive appliances. The advantages of the device are its simplified structure, the reduced waste of energy, the ability for operation with different moving playground equipment such as swings, seesaws, trampolines and others, as well as mobile play equipment and toys shaped like animals, automobiles, etc., for use in children's establishments and at home. It also allows for the attachment of various interactive appliances which produce visual and sound effects for the enhancement of kids' positive experiences.

1. A device for powering interactive appliances in moving playground equipment, the device comprising an electrical generator mounted onto the moving element of the playground equipment, characterized by the design of the electrical generator, which includes a case (1) inside of which there is fixed a tube (7) made out of an insulating material, on the tubes periphery surface there are fixed n number of coils (4) where n is greater or equal to one, and where the coils (4) are divided from each other by separating insolating elements (3), inside the tube it is placed a permanent cylindrical magnet (5) allowing for its sidestep movement along the tube, at the two ends of the tube (7) there are fixed rebound elements (6), and where the terminals of single coils or a group of connected coils (4) are terminals of the powering device, connected to the interactive appliances.

2. A device in accordance with claim 1, characterized with rebound elements (6) formed using permanent magnets with their opposite poles aimed toward the cylindrical magnet (5).

3. A device in accordance with claim 1 characterized with rebound elements (6) formed using rubber plugs, spring or elastic non-magnetic elements.

4. A device in accordance with claim 1 characterized with the n number of coils (4) being between 2 and 15.
